(19) United States
(12) Patent Application Publication
(10) Pub. No.: US 2023/0206052 A1
(43) Pub. Date: Jun. 29, 2023

(54) SYSTOLIC ARRAY STRUCTURE AND APPARATUS USING DIFFERENTIAL VALUE

(71) Applicant: KOREA ELECTRONICS TECHNOLOGY INSTITUTE, Seongnam-si (KR)

(72) Inventors: Dongyeob Shin, Seoul (KR); Yong Seok Lim, Seoul (KR)

(21) Appl. No.: 18/146,727

(22) Filed: Dec. 27, 2022

Related U.S. Application Data
(60) Provisional application No. 63/294,299, filed on Dec. 28, 2021.

(51) Int. Cl. G06N 3/063; G06F 7/544

(52) U.S. Cl. CPC G06N 3/063; G06F 7/5443

(57) ABSTRACT

Provided are a systolic array structure and a device including the same. The systolic array structure includes a processing element (PE) array in which a plurality of PEs are connected. The systolic array structure performs a multiply and accumulate (MAC) operation by applying differential values as first and second inputs which are input to each of the PEs.

### CROSS-REFERENCE TO RELATED APPLICATION

This application claims priority to and the benefit of U.S. Patent Application No. 63/294,299, filed on Dec. 28, 2021, the disclosure of which is incorporated herein by reference in its entirety.

### BACKGROUND

### 1. Field of the Invention

The present invention relates to a systolic array-related technology, and more particularly, to a technology for performing a corresponding operation using a differential value by simply adding an adder and the like to a result value accumulator in a systolic array structure for performing operations related to deep learning and the like.

### 2. Discussion of Related Art

A hardware design technology employing a differential value is used in various hardware designs based on a filter such as a finite impulse response (FIR) filter or the like. According to the technology employing a differential value, it is possible to obtain the same operation result with a smaller hardware area than that of the related art using a difference between operands multiplied by a common term due to an arithmetic property in an operation with the common term.

In particular, a technology for using a differential value in deep learning accelerator hardware (hereinafter, “related technology”) is being proposed. However, the related technology is only applied to dot-product operations or simple structures such as a structure obtained by folding a dot product and the like. Accordingly, there is a limitation to reducing the area of hardware for deep learning.

For example, the related art has a limitation in that a differential value is selectively applied to only one of two inputs for multiplication. In other words, according to the related technology, a differential value is applied as only one of a weight and an input (i.e., an input which is output from an input layer node, an input activation which is output from a hidden layer node, etc.) in a deep learning operation. Hereinafter, a weight to which a differential value is applied will be referred to as a “differential weight,” and an input to which a differential value is applied will be referred to as a “differential input.” In other words, the related technology employs only one of a differential weight and a differential input.

Meanwhile, a systolic array is a hardware structure that is proposed to increase efficiency in matrix operations. In particular, in a systolic array, major operations of deep learning are based on matrix operations or replaceable with matrix operations. Accordingly, a systolic array is an efficient structure to apply to a deep learning accelerator.

However, there is still no technology for performing a corresponding operation using a differential value in a systolic structure provided for operations related to deep learning and the like.

The above description merely provides the background information of the present invention and does not correspond to a technology disclosed in advance.

### SUMMARY OF THE INVENTION

The present invention is directed to providing a technology for using a differential value in a corresponding operation by simply adding an adder and the like to a result value accumulator in a systolic array structure for performing operations related to deep learning and the like.

The present invention is also directed to providing a technology for applying differential values to an operation related to deep learning and the like performed in hardware based on a systolic array structure so as to compensate an operation result based on the differential values and thereby reducing the area and power consumption of the hardware.

Objectives of the present invention are not limited to those described above, and other objectives which have not been described will be clearly understood by those skilled in the technical field to which the present invention pertains.

According to an aspect of the present invention, there is provided a systolic array structure including a processing element (PE) array in which a plurality of PEs are connected. The systolic array structure performs a multiply and accumulate (MAC) operation by applying differential values as a first input and a second input which are input to each of the PEs.

The PE array may include PEs configured to only apply the differential values to the first input and PEs configured to apply the differential values to both of the first and second inputs.

The differential values may be applied to values subsequent to a first value of each of the first and second inputs.

In each of the PEs, the first input may be preloaded and set, and the second input may be systolically input.

Reduced processing elements (RPE's) which are PEs disposed in a first column of the PE array may have higher bit-precision than RPEs which are PEs disposed in other columns with respect to the first input, and the RPE's and the RPEs may have the same bit-precision with respect to the second input.

Values of the first input of RPE's which are PEs disposed in a first column of the PE array may have a smaller number of bits than values of the first input of RPEs which are PEs disposed in other columns, and values of the second input of the RPE's and values of the second input of the RPEs may have the same number of bits.

The differential values may be applied to values of the first input of the RPEs.

A first value of the second input may be divided into m (m is a natural number larger than or equal to 2) parts and then sequentially input to the RPE's over m cycles, and the differential values may be applied to other values of the second input.

Each of the m input parts may have the same number of bits as the other values of the second input to which the differential values are applied.

The systolic array structure may further include a compensator configured to compensate for the differential values.

The compensator may use a previous accumulation value of each column in the PE array to compensate for the differential values of the second input which are systolically input and may use an accumulation value of a previous column in the PE array to compensate for the differential values of the first input which are preloaded and set.

The MAC operation may be an operation related to deep learning.

The first input may be weights, and the second input may be activations which are output from nodes of an input layer or activations calculated at nodes of any one hidden layer and output to nodes of a next hidden layer or an output layer.

According to another aspect of the present invention, there is provided a device including a memory and a processor configured to use information stored in the memory. The processor includes a systolic array structure having a PE array in which a plurality of PEs are connected. The systolic array structure performs a MAC operation by applying differential values to a first input and a second input which are input to each of the PEs.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic block diagram of a device 100 according to an exemplary embodiment of the present invention;

FIG. 2 is a diagram illustrating an example of a convolution operation process employing differential values;

FIG. 3 is a set of graphs showing distribution of input values (upside) and distribution of differential values (downside) for five convolution layers CONV1 to CONV5 of AlexNet among deep learning neural networks;

FIG. 4 is a diagram showing a general finite impulse response (FIR) filter structure;

FIG. 5 is a diagram showing a structure of an FIR filter in which differential values are applied as only one type of input as a case of applying differential values to FIG. 4;

FIG. 6 shows equations for an operation process performed in the FIR filter of FIG. 5;

FIG. 7 shows an example of a structure and operation of hardware based on a general systolic array;

FIG. 8 is a schematic block diagram of a processing element (PE) of a systolic array; and

FIG. 9 shows an example of a structure and operation of hardware based on a systolic array according to an exemplary embodiment of the present invention.

### DETAILED DESCRIPTION OF EXEMPLARY EMBODIMENTS

The above objectives and means of the present invention and effects thereof will become apparent through the following detailed description related to the accompanying drawings, and accordingly, those of ordinary skill in the art may easily implement the technical spirit of the present invention. In describing the present invention, when it is deemed that detailed description of known technology related to the present invention may unnecessarily obscure the gist of the present invention, the detailed description will be omitted.

Terminology used in this specification is for the purpose of describing exemplary embodiments and is not intended to limit the present invention. As used herein, a singular expression may include a plural expression in some cases unless the context clearly indicates to the contrary. As used herein, the expressions “include,” “comprise,” “have,” etc. do not exclude the existence or addition of one or more components other than stated components.

As used herein, the terms “or,” “at least one,” etc. may denote one of the elements that are listed together or a combination of two or more of the elements. For example, “A or B,” and “at least one of A and B” may include only one of A and B or both A and B.

In this specification, description following “for example” and the like may not exactly match the information presented, such as the recited characteristics, variables, or values, and the exemplary embodiments of the present invention should not be limited to effects such as variations including tolerances, measurement errors, limitations of measurement accuracy, and other commonly known factors.

In this specification, when a component is described as being “connected” or “coupled” to another component, it may be directly connected or coupled to the other component, but it should be understood that another component may be present therebetween. On the other hand, when a component is referred to as being “directly connected” or “directly coupled” to another component, it should be understood that there is no other component therebetween.

In this specification, when a component is described as being “on” or “adjacent to” another component, it may be directly in contact with or connected to the other component, but it should be understood that another component may be present therebetween. On the other hand, when a component is described as being “directly on” or “directly adjacent to” another component, it may be understood that there is no other component therebetween. Other expressions describing the relationship between components, for example, “between,” “directly between,” etc., may be interpreted in the same way.

In this specification, terms such as “first,” “second,” etc. may be used to describe various components, but the corresponding components should not be limited by the terms. Also, the terms should not be interpreted as limiting the order of components and may be used for the purpose of distinguishing one component from another component. For example, a “first component” may be named a “second component,” and similarly, a “second component” may be named a “first component.”

Unless otherwise defined, all terms used herein may be used with meanings that can be commonly understood by those of ordinary skill in the art. Also, terms defined in a commonly used dictionary are not interpreted ideally or excessively unless clearly so defined

Hereinafter, exemplary embodiments of the present invention will be described in detail with reference to the accompanying drawings.

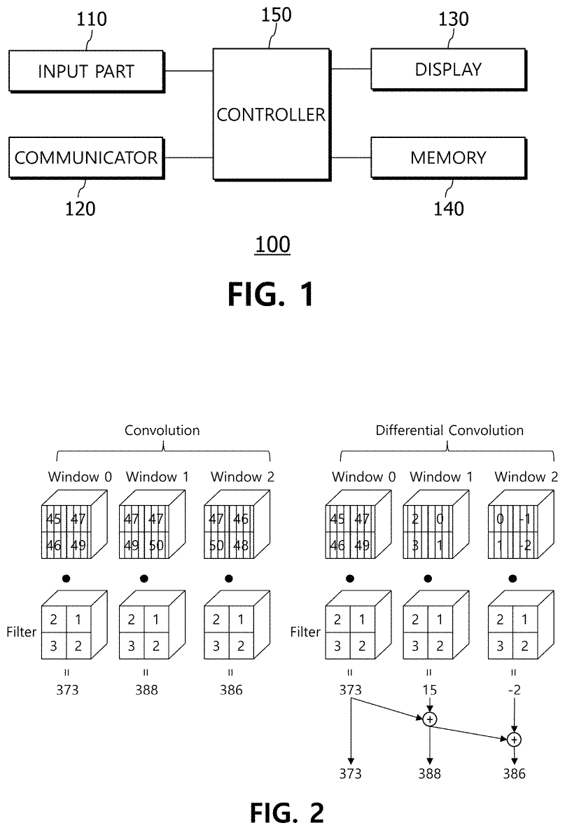

FIG. 1 is a schematic block diagram of a device 100 according to an exemplary embodiment of the present invention.

The device 100 according to the exemplary embodiment of the present invention (hereinafter, the “present device”) includes a systolic array structure employing differential values and is a device that performs a plurality of multiply and accumulate (MAC) operations through the systolic array structure.

For example, operations to be performed by the present device 100 may include operations related to deep learning and the like but are not limited thereto. In the case of performing operations related to deep learning, the present device 100 may include an artificial neural network for deep learning (hereinafter, a “deep learning neural network”).

For example, the deep learning neural network may include a deep neural network (DNN), a convolutional neural network (CNN), a recurrent neural network (RNN), a restricted Boltzmann machine (RBM), a deep belief network (DBN), a deep Q-network, etc. but is not limited thereto.

The deep learning neural network includes an input layer, a hidden layer, and an output layer, and each of the input layer, the hidden layer, and the output layer may include at least one node (also referred to as a “neuron”). It is obvious that the deep learning neural network includes a plurality of hidden layers. At least two different types of data are input to one node. A first type of data is a weight (also referred to as “W”), and a second type of data is that generally referred to as input (also referred to as “I”). Here, the second type of input I is data that is output from a node of the input layer and input to a node of a first hidden layer or data that is calculated as a value of a node of any one hidden layer (also referred to as “activation” or “A”). The second type of input I may be input to a node of a next hidden layer or the output layer.

In the case of a deep learning neural network for processing images, such as a CNN or the like, one node may indicate one element in a matrix of a feature map or filer (also referred to as “kernel”) included in a convolution layer or a pooling layer. In this case, the weight W which is the first type of data may be a value that an element of the filter has, and the input I which is the second type of data may be data that is output from a node of the input node and input to a node of a filter of the first hidden layer or data that is calculated as a value of a node in a feature map of any one hidden layer, and may be input to a node of a filter of a next hidden layer or a node of the output layer.

Also, the operations related to deep learning are operations performed in connection with deep learning at each node of the hidden layers or the output layer and may be operations that are performed in accordance with a learning process, a validation process, a test process, an inference process, etc. of deep learning. In other words, the operations related to deep learning may include MAC operations that are multiplication operations for weights W and inputs I and addition operations for results of the multiplication operations.

In particular, the present device 100 is an electronic device for computing and applies differential values as both of two types of data, weights W and inputs I, which are input for a deep learning operation in the systolic array structure. Here, a weight W to which a differential value is applied is referred to as a “differential weight,” and an input I to which a differential value is applied is referred to as a “differential input.” In other words, the systolic array of the present device 100 performs operations, such as an operation related to deep learning, using both of differential weights and differential inputs.

For example, the electronic device may be a general-use computing system, such as a desktop personal computer (PC), a laptop PC, a tablet PC, a netbook computer, a workstation, a personal digital assistant (PDA), a smartphone, a smart pad, a mobile phone, etc., or a dedicated embedded system which is implemented on the basis of embedded Linux or the like but is not limited thereto.

As shown in FIG. 1, the present device 100 may include an input part 110, a communicator 120, a display 130, a memory 140, and a controller 150. Here, the memory 140 and the controller 150 may be necessary components for operations related to deep learning based on a systolic array structure employing differential values, and the input part 110, the communicator 120, and the display 130 may be additional components.

The input part 110 may generate input data in accordance with various inputs of a user and include various input devices. For example, the input part 110 may include a keyboard, a keypad, a dome switch, a touch panel, a touch key, a touch pad, a mouse, a menu button, etc. but is not limited thereto.

The communicator 120 is a component that performs communication with other devices such as a terminal 200 and the like. For example, the communicator 120 may transmit or receive information required for an operation related to deep learning or result information of an operation related to deep learning to or from other devices. For example, the communicator 120 may perform wireless communication, such as fifth generation communication (5G), Long Term Evolution-Advanced (LTE-A), LTE, Bluetooth, Bluetooth Low Energy (BLE), Near Field Communication (NFC), WiFi, or other types of communication, or wired communication, such as cable communication or the like, but is not limited thereto.

The display 130 is a component that displays various video data on a screen and may be a non-light-emitting panel or a light-emitting panel. For example, the display 130 may display various video data for differential value processing, an operation related to deep learning, etc. As examples, the display 130 may be a liquid crystal display (LCD), a light-emitting diode (LED) display, an organic LED (OLED) display, a microelectromechanical systems (MEMS) display, an electronic paper display, etc. but is not limited thereto. Also, the display 130 may be implemented as a touch screen or the like in combination with the input part 110.

The memory 140 stores various information required for operations of the present device 100. For example, the information stored in the memory 140 may include information related to the deep learning neural network, information required for operations related to deep learning, program information related to operations of a systolic array structure 151 to be described below, etc. but is not limited thereto.

As examples, the memory 140 may include a hard disk type memory, a magnetic media type memory, a compact disc read only memory (CD-ROM) type memory, an optical media type memory, a magneto-optical media type memory, a multimedia card micro type memory, a flash memory type memory, a read only memory (ROM) type memory, a random access memory (RAM) type memory, etc. but is not limited thereto. Also, the memory 140 may be a cache, a buffer, a main memory, or an auxiliary memory in accordance with the use or location or a separately provided storage system but is not limited thereto.

The controller 150 may perform various control operations of the present device 100. In other words, the controller 150 may perform a first control function for controlling operations of other components, that is, the input part 110, the communicator 120, the display 130, the memory 140, etc. Also, the controller 150 may perform a second control function for controlling operations of the systolic array structure 151 to be described below.

The controller 150 may include a processor which is hardware, a process which is software executed by the processor, etc. Here, the controller 150 may include a plurality of processors. In other words, a first processor may perform the first control function, and the first processor or a second processor may perform the second control function.

For example, the first processor may be a microprocessor, a central processing unit (CPU), a processor core, a multiprocessor, an application-specific integrated circuit (ASIC), a field programmable gate array (FPGA), etc., and the second processor may be an artificial intelligence (AI) accelerator, a neural processing unit (NPU), a tensor processing unit (TPU), a graphics processing unit (GPU), etc. but the first processor and the second processor are not limited thereto.

Meanwhile, hardware 151 based on a systolic array according to an exemplary embodiment of the present invention (hereinafter, the “present systolic array structure”) is a systolic array structure employing differential values. In other words, the present systolic array structure 151 employs differential values in operations, such as an operation related to deep learning, and may perform a plurality of MAC operations using both of differential weights and differential inputs which are two types of inputs.

The second control function may be performed in accordance with the present systolic array structure 151, and the first or second processor of the controller 150 may include the present systolic array structure 151. In other words, the first or second processor may include the present systolic array structure 151 for operations such as an operation related to deep learning and the like.

FIG. 2 is a diagram illustrating an example of a convolution operation process employing differential values.

Referring to FIG. 2, convolution involves a matrix operation (i.e., an MAC operation) for inputs of different windows (Windows 0 to 2 in FIG. 2) with respect to one filter. On the other hand, an operation employing differential values is not an operation of repeating the same filtering operation for similar input data but is an operation of only calculating a difference from an existing input and obtaining an operation result by adding the difference to an existing value. In other words, as shown on the right side of FIG. 2, a value of (Window 1−Window 0) is used for Window 1 to obtain a result of 15, and a value of (Window 2−Window 1) is used for Window 2 to obtain a result of −2. When the results are added to 373 and 388 which are previous operation results, it is possible to finally obtain the same result values as those of convolution.

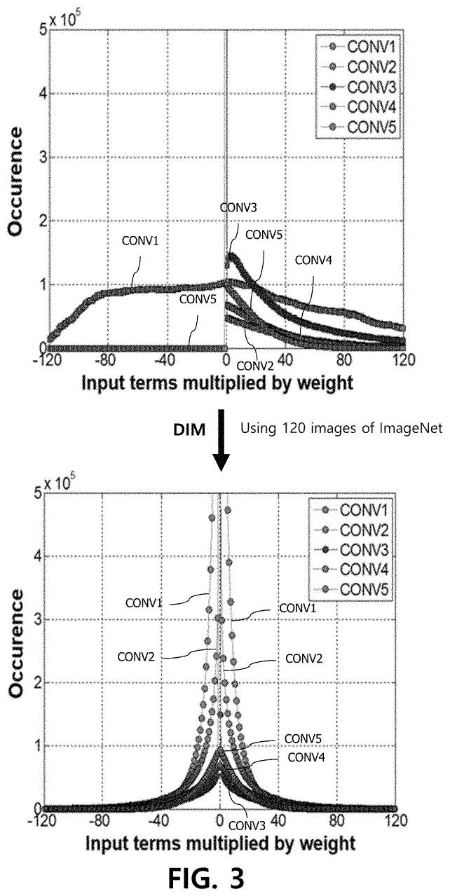

FIG. 3 is a set of graphs showing distribution of input values (upside) and distribution of differential values (downside) for five convolution layers CONV1 to CONV5 of AlexNet among deep learning neural networks.

As shown in FIG. 3, when an MAC operation and the like is performed using a differential value, the range of a value is reduced compared to that of a case in which the operation is performed using a general input value. This means that, when a differential value is used, it is possible to reduce the area and power consumption of hardware in proportion to a reduction in bit-precision through an operation having lower bit-precision.

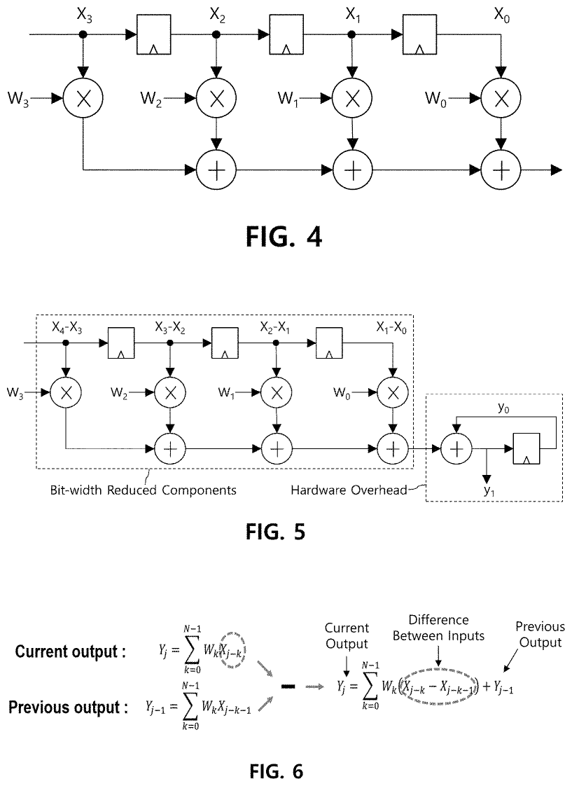

FIG. 4 is a diagram showing a general finite impulse response (FIR) filter structure, and FIG. 5 is a diagram showing a structure of an FIR filter in which differential values are applied as only one type of input as a case of applying differential values to FIG. 4. Also, FIG. 6 shows equations for an operation process performed in the FIR filter of FIG. 5.

In FIG. 4, an output has a value of X₀W₀+X₁W₁+X₂W₂+X₃W₃. When differential values are applied as inputs of the structure of FIG. 4, the structure is changed into a structure shown in FIG. 5. As shown in FIG. 5, when an adder for performing an addition operation of a previous output and a flip-flop are added to the existing structure (FIG. 4), an operation employing differential values is possible. Since the bit-precision of an input part is reduced as represented by (X₁−X₀)W₀ in FIG. 5, each multiplier may have a smaller area and smaller power consumption than an existing multiplier (FIG. 4). With an increase in the number of multipliers (with an increase in the number of taps in an FIR filter), the benefit of multipliers resulting from a reduction in bit-precision further outweighs hardware overhead for using differential values. With regard to FIG. 5, a part for performing an addition operation of a previous output and a part in which differential values are applied as an input may be represented by equations as shown in FIG. 6.

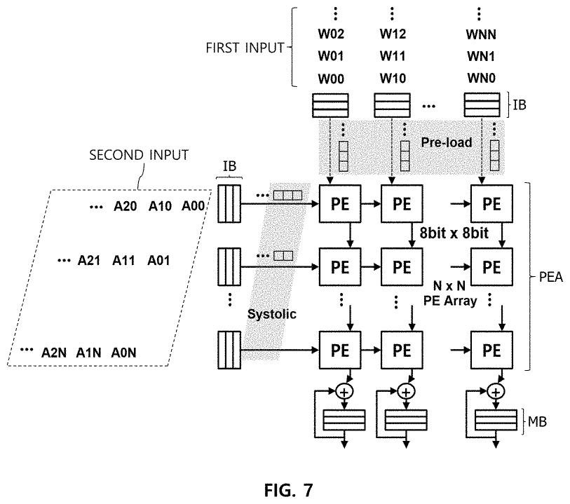

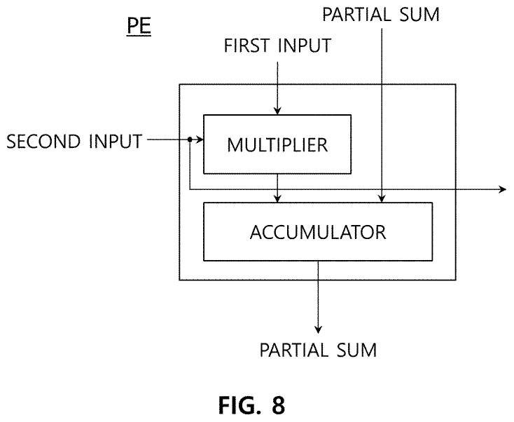

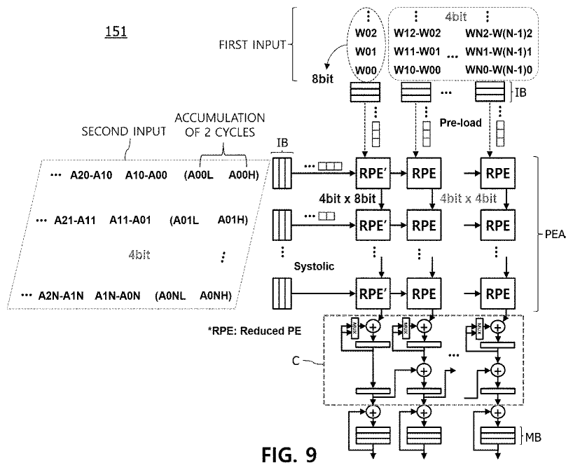

FIG. 7 shows an example of a structure and operation of hardware based on a general systolic array, and FIG. 8 is a schematic block diagram of a processing element (PE) of a systolic array.

As shown FIG. 7, the systolic array structure includes a PE array PEA in which PEs are connected to each other in a two-dimensional (2D) array, input buffers IB for scheduling inputs of an operation, and medium buffers MB for accumulating operation results of the PE array PEA and storing intermediate values. Referring to FIG. 8, each PE includes a multiplier and an accumulator. In each PE, the multiplier performs a multiplication operation of first and second inputs, and the accumulator accumulates the result of the multiplier. In the systolic array structure, such PEs are configured in the form of an array and shift input data and operation results to adjacent PEs, thereby minimizing data movement for an operation.

In other words, the systolic array structure is efficient for matrix operations mainly including MAC operations and takes data movement energy into consideration. Accordingly, the systolic array structure can be used as a hardware structure for deep learning operations of a deep learning neural network and the like which are based on a matrix operation and require a reduction in data movement.

In particular, systolic array structures include a 2D-systolic structure which systolically employs both of two inputs, and a one-dimensional (1D)-systolic structure which systolically employs only one input. In other words, in the 1D systolic structure, any one of first and second inputs (the first input in FIG. 7) is preloaded to and set in each PE, and only the other one (the second input in FIG. 7) is systolically processed. Referring to FIG. 7, in accordance with the 1D-systolic structure, for systolic processing, A00 to A0N corresponding to the second input are not input at the same clock cycle but are sequentially delayed by one clock cycle and input beginning with A00 and ending with A0N. After that, A10 to A1N are continuously and sequentially delayed by one clock cycle and input.

As an example, it may be assumed that a first PE and a second PE are adjacent in the vertical direction, a weight of W00 is preloaded to the first PE as a first input, and an activation of A00 is systolically input to the first PE as a second input. In this case, the multiplier of the first PE performs a multiplication operation of the first input of W00 and the second input of A00 (W00×A00), and the accumulator of the first PE accumulates the result of the multiplier (R0=W00×A00) and a previous partial sum (i.e., a first partial sum) and then transfers a partial sum (i.e., a second partial sum) which is the result of the accumulation to the adder of the second PE. Accordingly, the second PE performs the same operation as the first PE using the first input which is preloaded and set and a second input which is systolically input.

The present systolic array structure 151 may be implemented to use differential values in operations, such as operations related to deep learning, by changing the 1D-systolic structure.

FIG. 9 shows an example of a structure and operation of hardware based on a systolic array according to an exemplary embodiment of the present invention.

Referring to FIG. 9, the present systolic array structure 151 includes the PE array PEA, the input buffers IB, and the medium buffers MB described above with reference to FIG. 7. However, in the present systolic array structure 151, the PEs may receive first and second inputs having differential values and first and second inputs having reduced bit-precision unlike the PEs in the systolic array structure of FIG. 7. Accordingly, to emphasize such a reduction in bit-precision, a PE is indicated as a reduced PE (RPE′) or an RPE.

In other words, in the present systolic array structure 151, differential values are applicable to both of the first input W00 and the like and the second input A00 and the like. Here, differential values are applied to input values subsequent to first input values of the first and second inputs.

Like the existing PEs, each RPE′ and RPE includes a multiplier for performing a multiplication operation and an accumulator for performing an accumulation operation but may have lower bit-precision than the existing PEs.

Meanwhile, the present systolic array structure 151 further includes a compensator C. Referring to FIG. 9, the compensator C includes adders and flip-flops and is added between the PE array PEA and the medium buffers MB.

The compensator C performs an operation of compensating a previous value in accordance with differential values applied to first and second inputs. The compensator C may be configured of two stages. In the first stage, a differential value of the second input which is systolically input is compensated for using a previous accumulation value of a current PE column, and in the second stage, a differential value of the first input is compensated for using a result value of a previous PE column (the column immediately to the left in FIG. 9). When compensation is finished through the two stages, it is possible to obtain the same result value as the existing systolic array structure (FIG. 7).

For example, in the first stage, an accumulation value calculated by a first (leftmost) PE column from third input values of the second input is (A10−A00)*W00+(A11−A01)*W01+ . . . +(A1N−A0N)*W0N=(A10*W00+A11*W01+ . . . +A1N*W0N)−(A00*W00+A01*W01+ . . . +A0N*W0N). The second term (underlined) of the accumulation value is equal to a previous accumulation value (A00*W00+A01*W01+ . . . +A0N*W0N) of the first PE column. Accordingly, excluding parts offset against each other when a previous accumulation value to a current accumulation value, (A10*W00+A11*W01+ . . . +A1N*W0N), that is, an originally desired operation result of A10 to A1N (8 bits) and W00 to W0N, can be obtained using only four bits. Also, a final accumulation value (A10*W00+A11*W01+ . . . +A1N*W0N) of the first PE column in the first stage is used for compensation in a second PE column in the second stage. When a first-stage accumulation operation of the second PE column is performed, {(A10−A00)*(W10−W00)+(A11−A01)*(W11−W01)+(A1N−A0N)*(W1N−W0N)}+{A00*(W10−W00)+A01*(W11−W01)+ . . . +A0N*(W1N−W0N)}={A10*(W10−W00)+A11*(W11−W01)+ . . . +A1N*(W1N−W0N)} becomes a first-stage accumulation value of the second PE column. When the first-stage accumulation value is compensated for using (added to) the final accumulation value (A10*W00+A11*W01+ . . . +A1N*W0N) of the first PE column, an originally desired 8-bit operation result (A10*W10+A11*W11+ . . . +A1N*W1N) of A10 to A1N (8 bits) and W10 to W1N (8 bits) can be obtained as a 4-bit operation result of A10−A00 to A1N−A0N (4 bits) and W10−W00 to W1N−W0N (4 bits). Here, * represents multiplication.

Meanwhile, no differential value is applied as first values W00, W01, . . . of the first input and a first value A00 of the second input. This is because in the case of applying differential values as first values of the first and second inputs, it is necessary to apply the differential values by subtracting a bias value instead of a previous value which is not present, and this leads to an increase in additional operation overhead.

However, first values A00, A01, . . . of the second input influence bit-precision of all the PEs, and thus it may be preferable to divide the first values into m (m is a natural number larger than or equal to 2) parts in accordance with bit places and sequentially input the m parts over m cycles. In other words, when m is 2, first values A00, A01, . . . of the second input are divided into first bit parts A00H, A01H, . . . of higher places and second bit parts A00L, A01L, . . . of lower places and input. Here, each of the first and second bit parts has the same number of bits as values of the second input which are input as differential values after the first values, that is, second values and the like A10−A00, A20−A10, A11−A01, A21−A11, . . . of the second input. Accordingly, calculation is performed in accordance with the reduced bit-precision of a differential value, and the calculation can be controlled by adding a simple multiplexer MUX to the first stage of the compensator C.

For example, when m equals 2 and A00 has eight bits, A00H which is a first bit part includes four bits which correspond to the 2⁷, 2⁶, 2⁵, and 2⁴ places, and A00L which is a second bit part includes four bits which correspond to the 2³, 2², 2¹, and 2⁰ places. The values A10−A00, A20−A10, . . . of the second input subsequent to the first values have four bits.

Meanwhile, the first values W00, W01, . . . of the first input only influence the first PE column. When the first values are divided into m bit parts and input over multiple cycles like the first values A00, A01, . . . of the second input, overall data flow may be broken, or hardware overhead may increase. Accordingly, RPE's which are PEs of the first PE column have the same bit-precision as the existing PEs with respect to the first input. Therefore, the RPE's have a larger area (e.g., 4 bits×8 bits) than RPEs.

In other words, in FIG. 9, values of the first input to which no differential value is applied (i.e., general values) are preloaded and set in the RPE's which are PEs disposed in the first column on the basis of the first input which is systolically input. Accordingly, the RPE's have the same bit-precision as the existing PEs (FIG. 7) with respect to the first input. On the other hand, differential weights of the first input having differential values are preloaded and set in the RPEs which are PEs of columns other than the RPE's of the first column. Accordingly, the RPEs can have the same bit-precision lower than that of the existing PEs with respect to the first input.

For example, referring to FIG. 9, it is assumed that W00, W10, W20, . . . are input as the first input. In this case, W00 is input without change as a first value of the first input to the leftmost PE (RPE′) among PEs in a first row. On the other hand, differential values are input to second and other PEs (RPEs). In other words, a differential value of W10−W00 is input as a second value of the first input to the second PE (PRE), and a differential value of W20−W10 is input as a third value of the first input to the third PE (PRE).

Meanwhile, in FIG. 9, the second input having values to which no differential value is applied (i.e., general values) are systolically input to the RPE's. Here, a first value of the second input is divided into m parts having the number of bits of a differential value corresponding to a subsequent value of the second input and then sequentially input over m cycles. After that, differential values (e.g., differential inputs) are input as other values of the second input. Accordingly, the RPE's and the RPEs can have the same bit-precision lower than that of the existing PEs with respect to the second input.

For example, referring to FIG. 9, it is assumed that A00, A10, A20, . . . are input as the second input to the uppermost RPE′ in the first column. In this case, A00H and A00L obtained by dividing A00 are input to the uppermost RPE′ as first and second input values of the second input. On the other hand, differential values are input to the uppermost RPE′ as third and other values. In other words, a differential value of A10−A00 is input to the uppermost RPE′ as a third value of the second input, and a differential value of A20−A10 is input to the uppermost RPE′ as a fourth value of the second input.

Therefore, in the present systolic array structure 151, PEs can have reduced bit-precision compared to those of the existing systolic array structure (FIG. 7). For example, when the existing PEs have a bit-precision of 8 bits×8 bits, the RPEs have a bit-precision of 4 bits×4 bits, and the RPE's have a bit-precision of 4 bits×8 bits.

In the present systolic array structure 151, overhead of the compensator C including adders is very small compared to hardware benefit of the multiplier part which occupies most of the area. Also, assuming that the PE array PEA is an N×N (N is a natural number larger than or equal to 2) array, the hardware benefit is in proportion to N², and the overhead of the compensator C is in proportion to N. Accordingly, with an increase of N, the hardware benefit increases.

According to the present invention configured as described above, adders and the like are simply added to a result value accumulator in a systolic array structure for performing operations related to deep learning and the like, and thus it is possible to use differential values in the operations.

Also, according to the present invention, differential values are used to compensate an operation result according to the differential value when an operation related to deep learning and the like is performed in hardware based on a systolic array structure. Accordingly, it is possible to reduce the area and power consumption of the hardware.

In other words, when differential values are used in an operation related to deep learning and the like, it is possible to have the same effect as reducing bit-precision. Due to the effect of such bit-precision reduction, it is possible to reduce the area and power consumption of hardware for the operation according to the present invention.

In particular, according to the present invention, differential values can be applied to both a first input of weights and a second input (i.e., inputs of input layer nodes, activations and the like of hidden layer nodes, etc.). Accordingly, the present invention has a greater hardware benefit than the related technology for applying differential values to only one of first and second inputs.

For example, it may be assumed that each bit-precision may be halved through differential weights (weights to which differential values are applied) and differential inputs (inputs to which differential values are applied). In this case, according to the related technology, only one kind of differential weights and differential inputs is applied, and thus the overall bit-precision is halved. Therefore, the overall area and power consumption of hardware are halved. On the other hand, according to the present invention, both of differential weights and differential inputs are applied, and thus the overall bit-precision is reduced to a quarter (i.e., halved by differential weights and halved by differential inputs). Therefore, the overall area and power consumption of hardware are reduced to a quarter. Consequently, according to the present invention, it is possible to obtain a greater benefit than the related technology.

Further, according to the present invention, it is possible to apply hardware based on a systolic array to an electronic device (e.g., a mobile phone, an edge, a server, etc.) that processes operations related to deep learning of a deep learning network and the like.

In particular, existing differential value utilization technologies are applied to an FIR filter, a dot product, and a structure obtained by folding a dot product, whereas the present invention has an advantage in that differential values can be applied as all inputs when used in a systolic array structure.

Effects obtainable from the present invention are not limited to those described above, and other effects which have not been described will be clearly understood by those skilled in the technical field to which the present invention pertains from the above description.

Although specific exemplary embodiments have been described in the detailed description of the present invention, various modifications are possible without departing from the scope of the present invention. Therefore, the scope of the present invention is not limited to the described exemplary embodiments and should be defined by the following claims and equivalents thereto.

What is claimed is:

1. A systolic array structure including a processing element (PE) array in which a plurality of PEs are connected,
wherein the systolic array structure performs a multiply and accumulate (MAC) operation by applying differential values to a first input and a second input which are input to each of the PEs.

2. The systolic array structure of claim 1, wherein the PE array comprises:
PEs configured to only apply the differential values to the first input; and
PEs configured to apply the differential values to both of the first and second inputs.

3. The systolic array structure of claim 1, wherein the differential values are applied to values subsequent to a first value of each of the first and second inputs.

4. The systolic array structure of claim 1, wherein, in each of the PEs, the first input is preloaded and set, and the second input is systolically input.

5. The systolic array structure of claim 4, wherein reduced processing elements (RPE's) which are PEs disposed in a first column of the PE array have higher bit-precision than RPEs which are PEs disposed in other columns with respect to the first input, and
the RPE's and the RPEs have the same bit-precision with respect to the second input.

6. The systolic array structure of claim 4, wherein values of the first input of reduced processing elements (RPE's) which are PEs disposed in a first column of the PE array have a smaller number of bits than values of the first input of RPEs which are PEs disposed in other columns, and
values of the second input of the RPE's and values of the second input of the RPEs have the same number of bits.

7. The systolic array structure of claim 6, wherein the differential values are applied to values of the first input of the RPEs.

8. The systolic array structure of claim 6, wherein a first value of the second input is divided into m (m is a natural number larger than or equal to 2) parts and then sequentially input to the RPE's over m cycles, and
the differential values are applied to other values of the second input.

9. The systolic array structure of claim 8, wherein each of the m input parts has the same number of bits as the other values of the second input to which the differential values are applied.

10. The systolic array structure of claim 1, further comprising a compensator configured to compensate for the differential values.

11. The systolic array structure of claim 10, wherein the compensator uses a previous accumulation value of each column in the PE array to compensate for the differential values of the second input which are systolically input and uses an accumulation value of a previous column in the PE array to compensate for the differential values of the first input which are preloaded and set.

12. The systolic array structure of claim 1, wherein the MAC operation is an operation related to deep learning.

13. The systolic array structure of claim 12, wherein the first input is weights, and
the second input is activations which are output from nodes of an input layer or activations which are calculated at nodes of any one hidden layer and output to nodes of a next hidden layer or an output layer.

14. A device comprising:
a memory; and
a processor configured to use information stored in the memory,
wherein the processor includes a systolic array structure having a processing element (PE) array in which a plurality of PEs are connected, and
the systolic array structure performs a multiply and accumulate (MAC) operation by applying differential values to a first input and a second input which are input to each of the PEs.

15. The device of claim 14, wherein the PE array comprises:
PEs configured to only apply the differential values to the first input; and
PEs configured to apply the differential values to both of the first and second inputs.

16. The device of claim 14, wherein, in each of the PEs, the first input is preloaded and set, and the second input is systolically input.

17. The device of claim 16, wherein values of the first input of reduced processing elements (RPE's) which are PEs disposed in a first column of the PE array have a smaller number of bits than values of the first input of RPEs which are PEs disposed in other columns, and
values of the second input of the RPE's and values of the second input of the RPEs have the same number of bits.

18. The device of claim 17, wherein a first value of the second input is divided into m (m is a natural number larger than or equal to 2) parts and then sequentially input to the RPE's over m cycles, and
the differential values are applied to other values of the second input.

19. The device of claim 18, wherein each of the m input parts has the same number of bits as the other values of the second input to which the differential values are applied.

20. The device of claim 14, further comprising a compensator configured to compensate for the differential values,
wherein the compensator uses a previous accumulation value of each column in the PE array to compensate for the differential values of the second input which are systolically input and uses an accumulation value of a previous column in the PE array to compensate for the differential values of the first input which are preloaded and set.
